(19) United States
(12) Patent Application Publication
(10) Pub. No.: US 2017/0326514 A1
(43) Pub. Date: Nov. 16, 2017

(54) OPENABLE TINTOMETRIC MACHINE

(71) Applicants: Luca DROCCO, Alba (CN) (IT); Mario DROCCO, Alba (CN) (IT)

(72) Inventors: Luca DROCCO, Alba (CN) (IT); Mario DROCCO, Alba (CN) (IT)

(21) Appl. No.: 15/522,694

(22) PCT Filed: Oct. 27, 2015
(86) PCT No.: PCT/IB2015/058261

§ 371 Date: Apr. 27, 2017

(30) Foreign Application Priority Data
Oct. 28, 2014 (IT) TO2014A000875

(51) Int. Cl. B01F 13/00; B01F 15/00; B01F 13/10

(52) U.S. Cl. CPC B01F 13/0018; B01F 15/00922; B01F 15/00928; B01F 13/1058; B01F 15/00155; B01F 2215/005

(57) ABSTRACT

A tintometric machine includes an external frame made from rigid material, which defines an internal area. The internal area houses at least one dispenser system, which can dispense at least one fluid, such as paint or dye, into a vessel or container. The dispenser system of the tintometric machine, includes one or more dispenser mechanisms and a plurality of canisters or containers. Each of the dispenser mechanisms includes at least one pump and at least one valve assembly, and the canisters or containers are connected to one or more dispenser mechanisms. The external frame of the machine has a shell-shaped structure that can be opened to divide the machine into at least two portions. Each portion contains a part of the dispenser system. By dividing the machine into portions, an inspection area is defined between the portions, which is accessible to an operator.

The present invention relates to a tintometric machine that can be opened for dividing it into at least two parts, each one comprising part of the devices included in the tintometric machine itself, for the purpose of facilitating the maintenance of the devices included therein.

Tintometric machines are known comprising an external structure for containing a plurality of containers or canisters to which one or more dispenser systems are connected, the latter being able to dispense a desired quantity of a fluid, such as paints, particularly dyes, into a vessel or container arranged in a dispensing station or emplacement.

Said machines must be extremely compact and versatile in terms of their possible applications (e.g. they must contain a large number of canisters to provide a wide range of colours), as well as easy to maintain.

Said machines must be compact and easy to use, and must require as little maintenance as possible.

On the other hand, in the event of a failure they must be easily repairable at low costs and with short downtimes.

Tintometric machines are known which comprise an external structure that includes a door allowing access to the internal area defined by the external structure itself. Said internal area houses the electric, electronic, mechanical and electromechanical devices included in the tintometric machine.

Said access door normally allows inspection of just a small portion of the internal area, and hence of the devices housed therein.

In order to reach those devices which are located farther from said door, said external structure needs to be removed. Normally this a complex and time-consuming task. In addition, in order to gain access to the central areas of the tintometric machine, in the solutions known in the art it may be necessary to remove some components to clear sufficient room for reaching the device in need of maintenance, even if the removed devices do not require any maintenance. This latter aspect makes for increased maintenance costs and times.

The present invention aims at solving the above-mentioned technical problems by providing a tintometric machine that can be opened to divide the machine into at least two parts, for the purpose of making all the parts of the machine easily and quickly accessible to an operator.

One aspect of the present invention relates to a tintometric machine comprising the features set out in the appended claim 1.

Auxiliary features of the present invention are set out in the appended dependent claims.

The features of the tintometric machine will become clear and apparent in the light of the following description of some possible embodiments thereof and of the annexed drawings, which illustrate one exemplary embodiment of the present invention. More in detail, the drawings respectively illustrate the following:

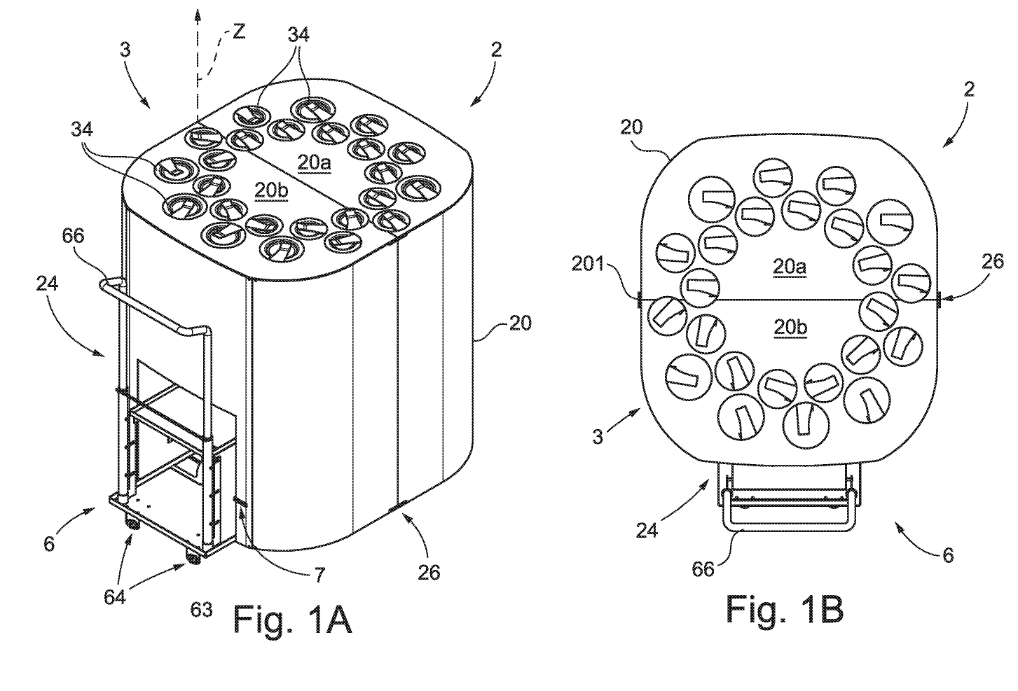

FIGS. 1A, 1B show one possible embodiment of the tintometric machine, in particular associated with a trolley, in a closed configuration; in particular, FIG. 1A shows an axonometric front view and FIG. 1B shows a top view of the machine;

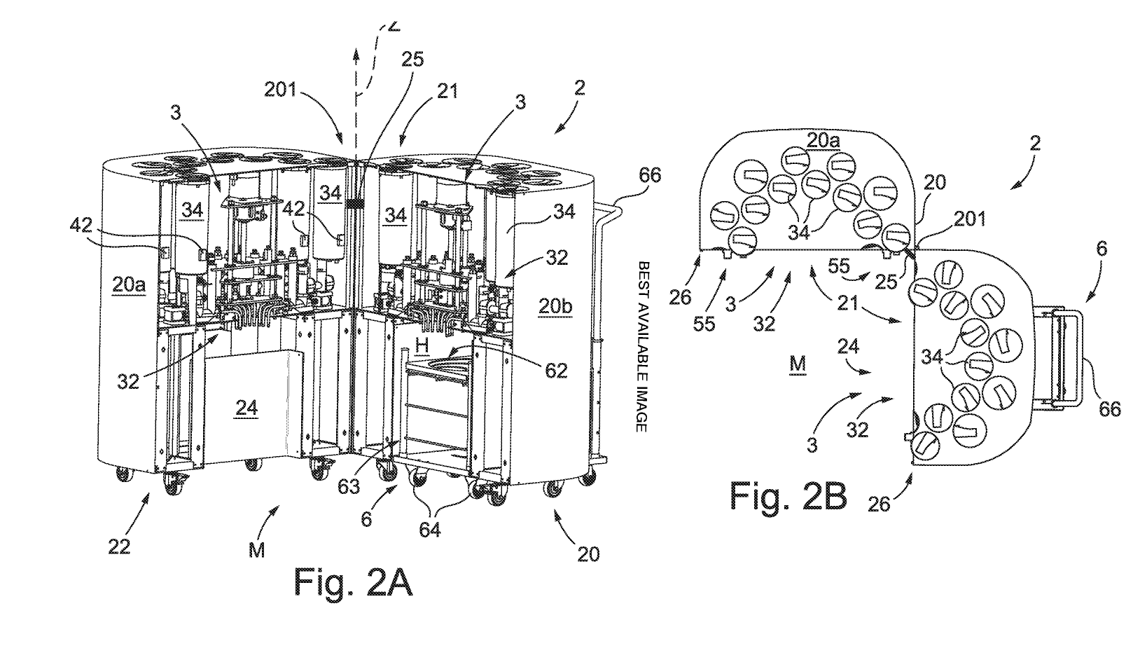

FIGS. 2A, 2B show one possible embodiment of the tintometric machine in an open configuration; in particular, FIG. 2A shows an axonometric front view and FIG. 2B shows a top view of the machine;

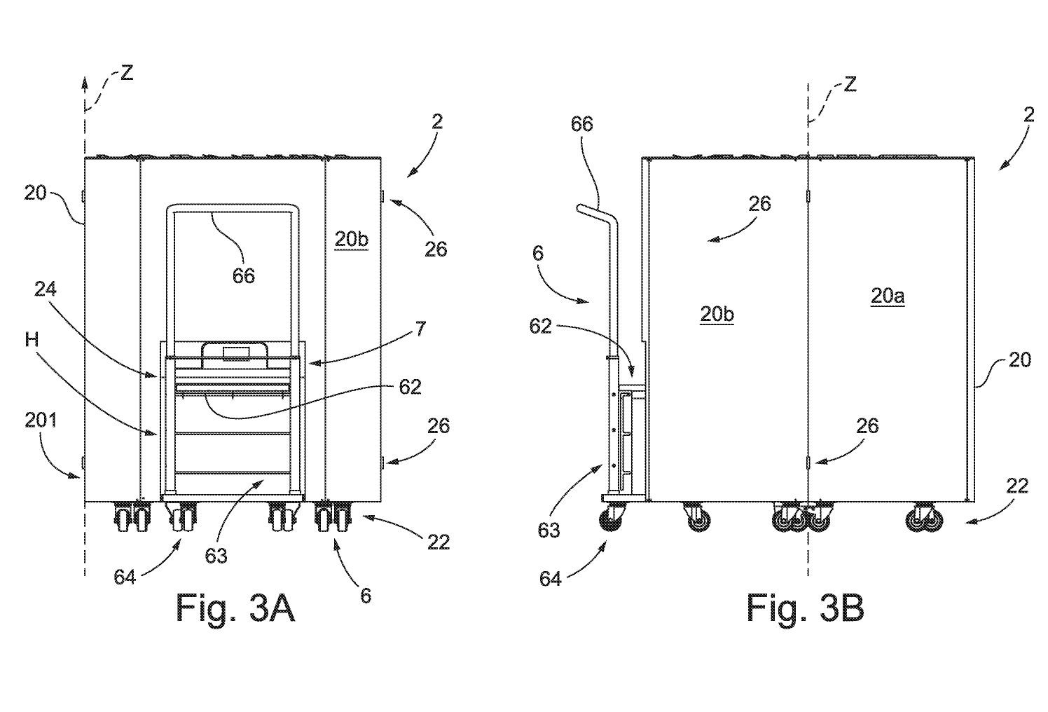

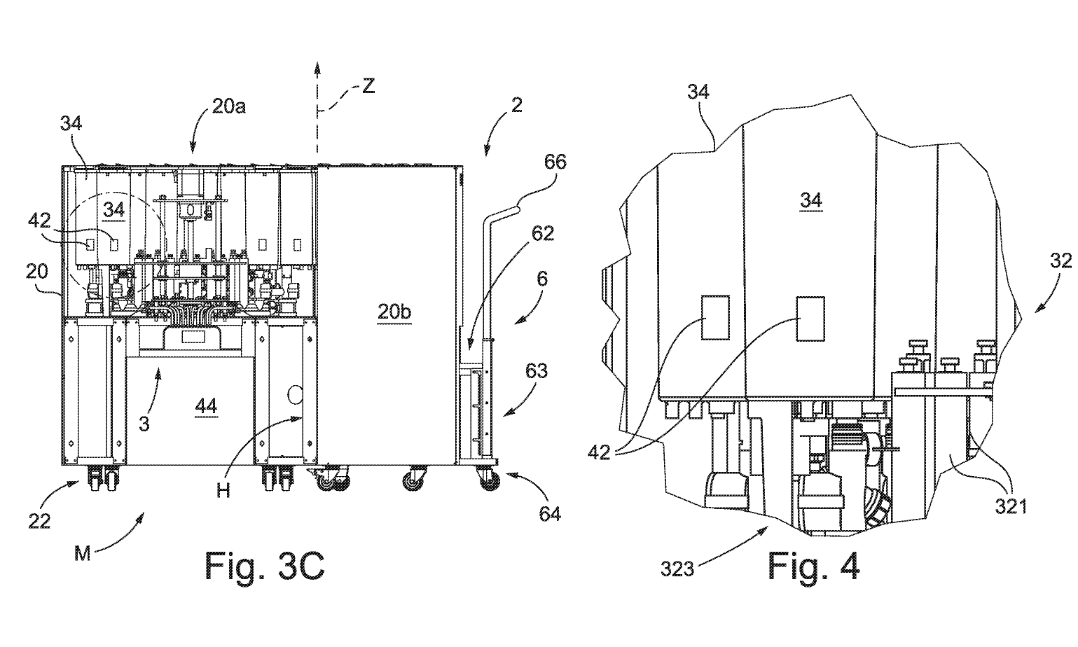

FIGS. 3A, 3B and 3C show one possible embodiment of the tintometric machine, in particular associated with a trolley, in the two different operating configurations; in particular, FIG. 3A shows a front view of the assembly in the closed configuration, FIG. 3B shows a side view of the assembly in a closed configuration of the machine, FIG. 3C shows a front view in an open operating configuration of the machine;

FIG. 4 shows the detail “A” encircled in FIG. 3C, wherein a dispenser mechanism and canisters fitted with level sensors are more visible;

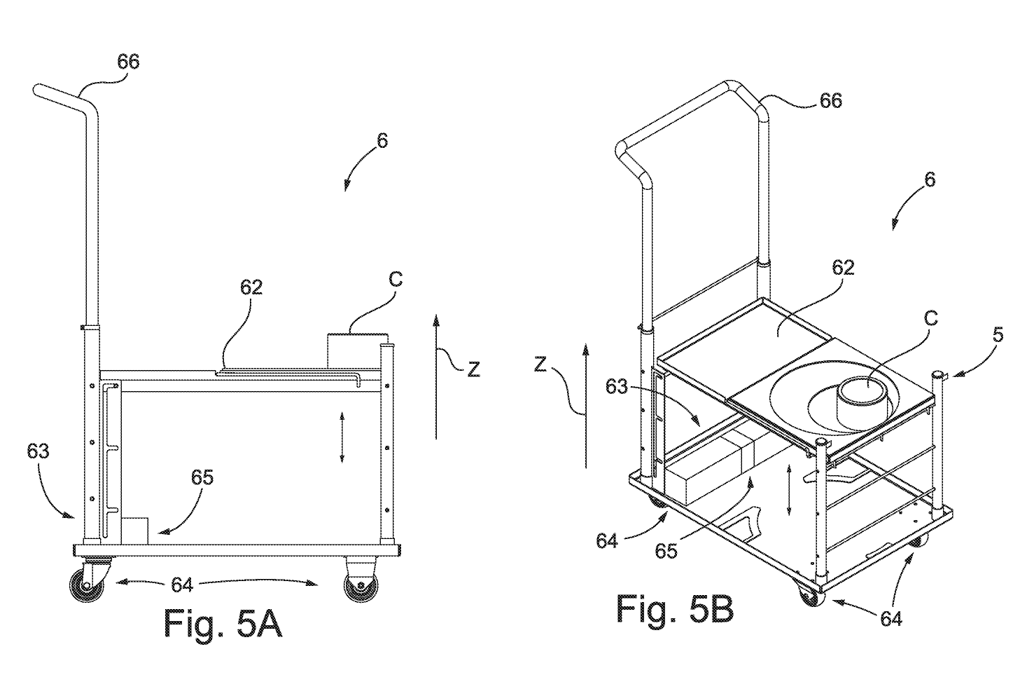

FIGS. 5A and 5B show two different views of the trolley; in particular, FIG. 5A shows a side view and FIG. 5B shows a perspective view;

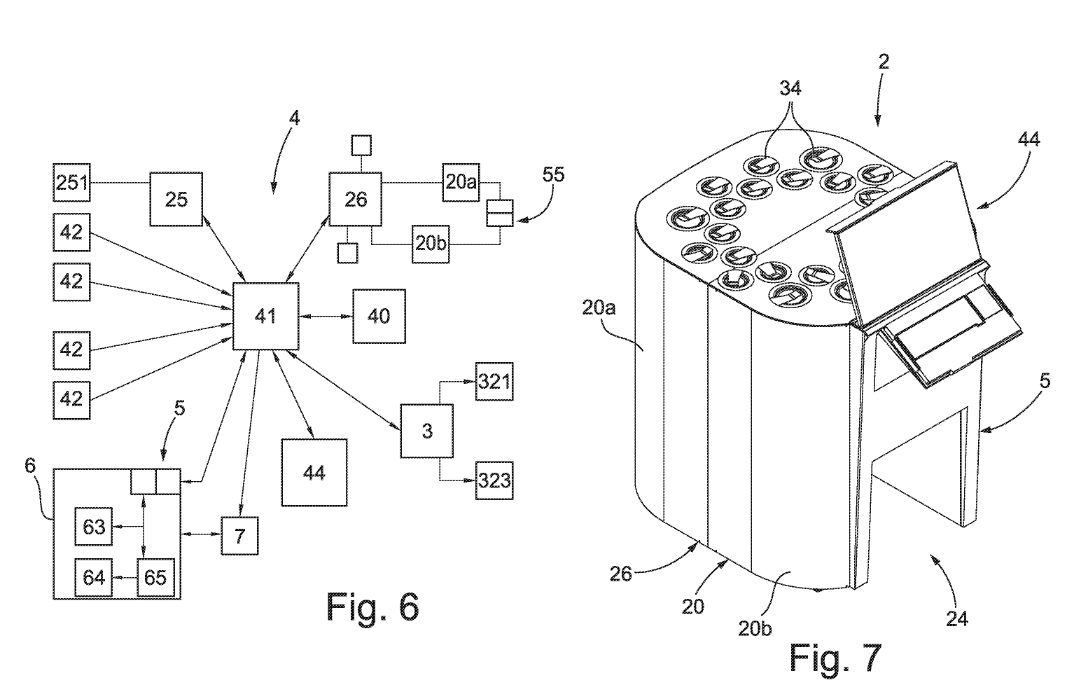

FIG. 6 shows a block diagram of the general control system for controlling the tintometric machine according to the present invention;

FIG. 7 shows an embodiment of the tintometric machine, comprising at least one user interface.

With reference to the above-listed figures, tintometric machine 2, which may be assembled together with a trolley 6, comprises an external frame 20 made from rigid material, such as, for example, metal or plastic materials, defining an internal area 21.

Said internal area 21 houses at least one dispenser system 3. Said dispenser system 3, included in tintometric machine 2, can dispense a fluid, e.g. a paint, in particular a dye, into a vessel or container “C”. Said vessel or container “C” is normally intended for use by the final user.

Said dispenser system 3 comprises a plurality of canisters or containers 34 and one or more dispenser mechanisms 32, each one comprising at least one pump 321 and at least one valve assembly 323, of a type known to those skilled in the art;

Said canisters or containers 34 are connected to one or more dispenser mechanisms 32 either in a direct manner, e.g. one dispenser mechanism 32 per canister 34, or in a sequential manner, thus sharing one or more dispenser mechanisms 34, as is known to those skilled in the art.

Being openable, said external frame 20 has a shell-shaped structure. External frame 20 can be opened in such a way that tintometric machine 2 will be divided into at least two portions (20a, 20b), which may also have different dimensions, i.e. portions that are not dimensionally equal.

In general, each portion (20a, 20b) contains a part of dispenser system 3, which is housed therein. By dividing said at least two portions, an inspection area “M” is defined between portions (20a, 20b), which is accessible to an operator. Said inspection area allows the operator to stand between portions (20a, 20b) of external frame 20, so that he can easily and directly see all the parts of dispenser system 3.

The exemplary FIGS. 2A and 2B show a tintometric machine 2 in the open configuration, wherein an inspection area “M” is defined between portions (20a,20b), and each portion comprising a part of dispenser system 3, in particular of the dispenser mechanisms, in addition to canisters or containers 34. This feature is also visible in FIG. 3C.

The present solution provides substantially direct access to all the parts of tintometric machine 2, while also clearing an area where the operator can comfortably carry out maintenance work without having to remove other components of the machine in order to gain access to the desired part and/or to work on the device requiring service or maintenance.

The portions are separated from each other, so that some parts of dispenser system 3 will remain associated with a first portion 20a and other parts will remain associated with a second portion, and so on for the whole number of portions into which said frame 20 can be opened and divided.

The exemplary embodiment shown in the annexed FIGS. 2A, 2B and 3C adopts a solution wherein the machine can be divided into two portions.

Whatever the number of portions with which tintometric machine 2 is divided, in the closed configuration the machine will have the shape shown by way of example in FIGS. 1A, 1B and 7.

In an alternative embodiment (not shown), the machine can be divided into three portions, e.g. a machine 2 wherein a first portion represents one half of the machine, while a second portion and a third portion constitute each one quarter of the machine. Dispenser system 3 may be equally distributed among the various parts, e.g. depending on the machine portion represented by them.

Preferably, said portions (20a, 20b) are hinged to each other in order to be able to rotate about a vertical axis “Z”, thus moving relative to each other.

In alternative embodiments, the two parts can be separated and slide along one or more longitudinal guides, e.g. arranged along an axis perpendicular to said vertical axis “Z”. Though not shown herein, hybrid forms envisaging a longitudinal motion followed by a rotary motion should also be considered as falling within the protection scope of the present invention.

In the above-mentioned embodiment comprising three portions, the second portion is hinged to one side of said first portion, and said third portion is hinged to the opposite side of the same first portion, so that it can rotate in between and take, in the closed configuration, a shape which is substantially similar to the one shown in FIGS. 1A and 1B.

The illustrated embodiment comprises at least one hinge 201, preferably at least three hinges, arranged along a vertical axis “Z” on one side of tintometric machine 2, so that portions (20a, 20b) can rotate about said axis “Z”. The relative motion between portions (20a, 20b) allows the creation of an inspection area “M” where the operator can stand, e.g. in order to carry out maintenance activities on tintometric machine 2.

In the illustrated embodiment, inspection area “M” has a wedge-like shape, including a circumference sector of 60° to 120°, preferably 90°. In particular, portions (20a,20b) can rotate by 60° to 120°, preferably 90°, relative to each other about a vertical axis “Z” whereto they are hinged.

FIGS. 2A, 2B and 3C show an embodiment wherein trolley 6 can remain associated with tintometric machine 2 even when the tintometric machine is in an open operating configuration, e.g. during maintenance. It is nevertheless envisaged that tintometric machine 2 can also be opened when the trolley is not associated with the tintometric machine.

In one possible embodiment of tintometric machine 2, an opening device 25 is included, which can open, or at least contribute to opening, machine 2, and in particular external frame 20. Said opening mechanism allows machine 2 to be opened in an at least partially automatic manner, thus moving said portions (20a 20b) for generating said inspection area “M”.

In a simpler but equally functional embodiment, the opening of machine 2, in particular of portions (20a, 20b), is effected in a substantially manual manner. For example, portions (20a, 20b) are manually secured or released by means of a lock, and portions (20a, 20b) are also moved manually for generating said area “M”.

The tintometric machine according to the present invention comprises a closing mechanism 26 that can hold together portions (20a 20b) of machine 2 when the same machine 2 is in a closed operating configuration, a first plug-socket system 55 being included for supplying power to at least a part of machine 2, e.g. to at least said dispenser system 3. In the assembled condition, said first plug-socket system 55 can conduct an electric current.

In particular, said closing mechanism 26 is an electric or electromechanical one, so as to avoid that said machine 2, and in particular external frame 20, might open accidentally. Said closing system 26 allows keeping tintometric machine 2 closed by means of electromechanical or electric fastening elements known to those skilled in the art.

Said closing mechanism 26 further comprises sensors capable of detecting when tintometric machine 2 has been properly closed.

Tintometric machine 2 comprises an electronic control system 4 for controlling at least one of opening mechanism 25 and closing mechanism 26.

Said electronic control system 4 is preferably also adapted to control also said sensors for detecting that machine 2 has been properly closed.

In turn, electronic control system 4 comprising a data processing unit 41.

One possible embodiment of the electronic control system and of its connections to the devices included in tintometric machine 2 is illustrated in FIG. 6.

In one possible embodiment, said opening mechanism 25 comprises at least one actuator 251 for exerting a force in order to move apart, at least partially, portions (20a 20b) of frame 20 of machine 2, for the purpose of contributing, at least partly, to generating said inspection area “M”.

Said at least one actuator 251 may be an electric or pneumatic device, such as an air spring or a thrust jack.

In the embodiment shown in the drawings, the portions are two, so that the machine will be divided into two halves.

FIGS. 1A and 1B show the machine in a closed configuration, whereas FIGS. 2A and 2B show the machine in an open configuration. As can be seen in the above-mentioned figures, portions (20a, 20b) internally comprise part of dispenser system 3, comprising part of canisters 34 and part of dispenser mechanisms 32. The present solution allows dividing entire tintometric machine 2 substantially in half.

Said closing system 26, as aforementioned, comprises at least one sensor for detecting when external frame 20 of tintometric machine 2 has been properly closed.

Said first plug-socket system 55 allows deactivating in a quick and safe manner at least said dispenser system 3 when tintometric machine 2 is in an open operating configuration. The same system allows, when the machine is brought back into the closed operating configuration, supplying power simply and quickly to said dispenser system 3. In the proposed solution, when machine 2 is opened all actuators will be de-energized, particularly those included in dispenser system 3, such as, for example, dispenser mechanisms 32.

In a preferred embodiment, said data processing unit 41 allows activating machine 2, e.g. for executing a step of dispensing one or more fluids, after having verified, e.g. upon interrogation, that closing system 26 has detected that the machine has been properly closed.

Said solution allows access to dispenser system 3 for maintenance purposes; in particular, dispenser mechanisms 32 are easily accessible, thus making maintenance easier.

Said tintometric machine 2 comprises a motion mechanism 22, e.g. wheels, for moving the same machine on a plane.

Said motion mechanism makes it easier to open tintometric machine 2, in that it promotes relative motion between portions (20a, 20b). One exemplary and non-limiting possible embodiment of the motion mechanism is visible in FIGS. 3A and 3B.

In a tintometric machine 2 according to the present invention, electronic control system 4 comprises, in addition to a data processing unit 41, also a plurality of level sensors 42, the latter being electrically connected to said data processing unit 41.

At least one level sensor 42 is associated with each canister or container 34 included in tintometric machine 2, in particular in dispenser system 3. FIG. 4 shows an embodiment wherein a number of canisters 34 are visible, with which said level sensors 42 are associated.

Said level sensor 42 is an electronic sensor. In the preferred embodiment, sensor 42 of the capacitive type.

Said capacitive sensors 42 are sensors that can be positioned on the outside of canister 34, thus being easily accessible for maintenance.

In the present embodiment, said data processing unit can acquire the data from level sensors 42 automatically. The data acquired by data processing unit 41 are used for monitoring the fluid levels in canisters or containers 34.

The solution according to the present invention allows monitoring the quantity of fluid contained in a canister 34, e.g. by determining the level thereof inside canister 34, even during the steps of filling and/or refilling the canister 34 with the respective fluid. The present solution can also determine if the quantity of fluid in canister 34 has reached a minimum level. One or both of the above-mentioned effects are obtainable through the use of electronic sensors, in particular capacitive level sensors.

The present solution turns out to be particularly simple and suitable for handling a large number of canisters 34, leading to lower production costs.

In an exemplary but non-limiting embodiment, said data processing unit 41 acquires the data from all level sensors 42. In one possible embodiment, acquisition may occur in a substantially simultaneous manner, or upon interrogation after the occurrence of an event, or periodically, or sequentially.

In a preferred embodiment of tintometric machine 2, the latter comprises a user interface 44 through which the user, for example, can obtain information about the operation of the machine.

Said user interface 44 is electrically connected to data processing unit 41.

The data acquired by data processing unit 41, received from level sensors 42, e.g. upon interrogation, are processed by processing unit 41 itself. The data thus processed are then returned, via user interface 44, in the form of at least one visual indication of the level, whether absolute or indicative, of the fluid contained in one or more canisters or containers 34. In a preferred embodiment, said user interface 44 can generate at least one visual indication about the level of all containers, whether simultaneously or for groups of one or more containers, e.g. upon request from the user/operator. As aforementioned, the visual indication thus obtained may represent the actual fluid contents of canister 34, or it may represent an estimate depending on input data, e.g. entered by an operator. At any rate, control system 4, in accordance with the present invention, will be at least able to return an actual indication when the quantity of fluid in a canister 34 reaches a predefined minimum threshold.

Said user interface 44 also allows providing a visual and/or audible indication about the operating state of the machine, e.g. indicating if the machine is in an open configuration or whether it has been properly closed or not. FIG. 7 shows one possible embodiment of user interface 44.

In the preferred but non-limiting embodiment, user interface 44 comprises at least one display. A data input device, such as a keyboard, or a pointing device, such as a mouse, may also be included, or all these functionalities may be integrated into an active screen, or “touch screen”.

The solution according to the present invention also allows, in addition to monitoring and controlling the level of product, in particular fluid, in each canister or container 34 included in tintometric machine 2, the execution of a diagnostic function in order to obtain a real-time update of the quantity of fluid in the canisters, at least if there is a preset minimum quantity. It may even be possible to obtain an estimate of the times by which maintenance activities will have to be carried out, such as filling or refilling one or more canisters 34 with product or fluid.

In the solution according to the present invention, said data processing unit 41, through a mathematical algorithm stored in a memory medium 40, preferably a non-volatile one, may be able to calculate and return, via user interface 44, a piece of information relating to an estimate of the time by which a maintenance activity will have to be carried out. In particular, said algorithm will be able to return an estimate of the times by which the fluid contents of one or more canisters 34 will become exhausted.

In an exemplary but non-limiting embodiment, said algorithm can provide an estimate of the time by which a fluid in one or more canisters 34 will become exhausted by executing the following steps:
calculating an average between the fluid quantities taken from at least one canister 34 and dispensed by dispenser system 3 during a predefined number of dispensing operations carried out by machine 2, e.g. a number of dispensing operations between 10 and 100.
calculating the number of dispensing operations still executable, considering the contents of one or more canisters 34, on the basis of the previously calculated quantity dispensed on average.

Said estimate may be referred to either a single container or, in general, to all containers.

Other types of computation algorithms may also be implemented, e.g. probabilistic ones.

Furthermore, said algorithm, and in particular the computer program which, when executed by said data processing unit 41, allows the execution of the steps of the algorithm, may be implemented in “machine learning” mode.

Preferably, at least after each dispensing operation carried out by tintometric machine 2, electronic control system 4 verifies the contents of one or more canisters 34, in particular of at least those used during the last dispensing operation.

Preferably, said electronic control system 4 is the same system that automatically controls dispenser system 3; in particular, it can control and drive dispenser mechanisms 32 in ways which are known to those skilled in the art. The same control system 4, in particular the same data processing unit 41, sends the data to user interface 44, for returning one or more visual or audible indications about the operation of tintometric machine 2, and may receive data, e.g. from the same user interface 44, for entering information about, for example, how to perform the dispensing operation, e.g. for the purpose of setting the dye to be obtained.

The same user interface 44 may be used for entering information about the times and/or quantities of product loaded in one or more canisters 34.

In one possible embodiment, said trolley 6 comprises a supporting top 62, whereon at least one container “C” can be placed; rotary elements 64, e.g. wheels, allowing the trolley 6 to move on a plane; and a gripping element 66, e.g. a handrail portion or a handle, through which the user can grip trolley 6 for exerting a force, whether directly or via an actuator, such as a motor, in order to move the trolley.

For example, said trolley 6 may comprise a propulsion system, e.g. an electric motor, capable of moving said rotary elements 64, such as, for example, wheels or tracks, for moving trolley 6.

Preferably, said supporting top 62 comprises a plurality of housings, e.g. coaxially arranged, allowing any vessel or container “C”, of any shape or dimensions, to be placed on the supporting top 62, ensuring that the vessel will be properly retained while moving trolley 6. One possible embodiment is shown by way of example in FIGS. 5A and 5B.

Said dispensing station 24 comprises a housing “H” into which said trolley 6 can be positioned.

The assembly made up of tintometric machine 2 and trolley 6 comprises a second plug-socket system 5, wherein a first part of system 5 is located on trolley 6 and a second part of the same system 5 is located in dispensing station 24. The parts of the second plug-socket system 5 can be assembled together when said trolley 6 is put into housing “H” of dispensing station 24.

In the assembled condition, said second plug-socket system 5 can conduct an electric current.

In general, trolley 6 according to the present invention is not permanently secured to tintometric machine 2, but can be moved and released from said tintometric machine 2.

Trolley 6 comprises an actuating device 63 that can move said supporting top 62 for the purpose of changing at least the dimension along a vertical axis “Z” of the same supporting top 62.

In one possible embodiment, said trolley 6 comprises a power supply device 65, e.g. an electric accumulation battery, which can at least supply power to said actuating device 63.

In the embodiment wherein said rotary elements 64 are drive wheels, the motion system of trolley 6 itself may be powered, at least partly, by power supply device 65.

In one embodiment, said actuator 63 can move said supporting top 62 at least along said vertical axis “Z”, e.g. by causing said supporting top 62 to slide along guides, e.g. formed in the very structure of trolley 6.

Said movable supporting top allows the assembly to introduce containers “C” of any shape and dimensions into tintometric machine 2.

In one possible alternative, said supporting top is driven by said actuating device 63, making a roto-translational movement. In a further possible embodiment, movement occurs by means of a double rotation.

The assembly according to the present invention comprises a locking device 7 capable of locking trolley 6 in housing “H” of dispensing station 24 of tintometric machine 2. In one possible embodiment, said locking device is a movable abutting element which, when activated upon proper positioning of trolley 6, will abut against the trolley to prevent any movement thereof, e.g. by positioning a locking element. In alternative embodiments, said locking device may be mechanical, electromechanical or electric.

Preferably, tintometric machine 2 comprises an electronic control system, which can control said actuating device 63 of trolley 6 when trolley 6 is in housing “H”, in particular when it is correctly positioned therein.

Preferably, the electronic control system controls actuating device 63 of the trolley when the second plug-socket system 5 is in the assembled configuration.

Said electronic control system is preferably the same electronic control system 4 already described herein.

Control system 4 can activate said actuating device 63 for moving said supporting top 62 in order to position it correctly at dispenser system 3 for the execution of a dispensing operation. Likewise, once tintometric machine 2 has completed the dispensing operation, electronic control system 4, in particular data processing unit 41, will activate actuating device 63 in order to cause the supporting top to make the opposite movement, so that trolley 6 can then be moved.

The correct movement of supporting top 62, and in particular of container or vessel “C” positioned thereon, is controlled by at least one sensor, which can determine the position of container “C” with respect to dispenser mechanisms 32. Said sensor may be a position or distance sensor, arranged either on trolley 6 or inside dispensing station 24.

In addition, said control system 4 is electrically connected to both said second plug/socket system 5 and said locking device 7. This electric connection allows monitoring the presence of trolley 6 in housing “H” of dispensing station 24 and activating locking system 7 accordingly in order to lock or release trolley 6.

Tintometric machine 2 and/or the assembly comprising trolley 6 offers all the previously mentioned advantages.

The present invention allows opening the tintometric machine to divide the machine into at least two parts, for the purpose of making all the parts of the machine easily and quickly accessible to an operator. The present solution allows reaching the devices that are located at the centre of the machine, which are hardly accessible in prior-art solutions. Furthermore, for providing access to central areas of the tintometric machine, the present solution does not require any components to be removed in order to clear sufficient room for reaching the device requiring maintenance, resulting in lower maintenance costs and shorter maintenance times.

### REFERENCE NUMERALS

Tintometric machine 2
External frame 20
Portions 20a,20b
Hinges 201
Internal area 21
Motion mechanism 22
Dispensing station 24
Opening mechanism 25
Actuator 251
Closing mechanism 26
Dispenser system 3
Dispenser mechanisms 32
Pump 321
Valve assembly 323
Canisters or containers 34
Electronic control system 4
Memory medium 40
Data processing unit 41
Level sensors 42
User interface 44
Second plug-socket system 5
First plug-socket system 55
Trolley 6
Supporting top 62
Actuating device 63
Rotary elements 64
Power supply device 65
Gripping element 66
Locking device 7
Vessel or container C
Housing H
Inspection area M
Vertical axis Z

1. A tintometric machine comprising an external frame made from rigid material, which defines an internal area;
said internal area houses at least one dispenser system, which can dispense at least one fluid into a vessel or container;
said dispenser system (3), being comprised in the tintometric machine (2), comprises one or more dispenser mechanisms and a plurality of canisters or containers;
each one of said dispenser mechanisms comprises at least one pump and at least one valve assembly; said canisters or containers are connected to one or more dispenser mechanisms; and
said external frame has a shell-shaped structure that can be opened to divide the machine into at least two portions, each one of the at least two portions containing a part of the dispenser system; the machine divided into portions defining an inspection area between the portions, which is accessible to an operator.

2. The machine according to claim 1, wherein said portions are hinged to each other to rotate about a vertical axis and moving relative to each other.

3. The machine according to claim 1, comprising an opening mechanism that can open the machine in an at least partially automatic manner, thus moving said portions for generating said inspection area.

4. The machine according to claim 2, comprising:
a closing mechanism that can hold together the portions of the machine when the machine is in a closed operating configuration; and
a plug/socket system (55) being included for supplying power to at least said dispenser system.

5. The machine according to claim 4, comprising a plurality of sensors for verifying that the machine has been closed properly.

6. The machine according to claim 1, comprising an electronic control system for controlling at least one of the opening mechanism and the closing mechanism.

7. The machine according to claim 3, wherein said opening mechanism comprises at least one actuator for exerting a force in order to move apart, at least partially, the portions of the frame of the machine.

8. The machine according to claim 1, wherein the portions are two, so that the machine will be divided into two halves.

9. The machine according to claim 1, comprising a motion mechanism 22, e.g. wheels, for moving the machine on a plane.

10. The machine according to claim 6, wherein the electronic control system comprises a data processing unit, a plurality of level sensors, the level sensors being electrically connected to said data processing unit; at least one electronic capacitive level sensor is associated with each canister or container in the dispenser system; said capacitive sensors are sensors that can be positioned on an outside of the canister, thus being easily accessible for maintenance.
